(19) United States
(12) Patent Application Publication
(10) Pub. No.: US 2014/0146003 A1
(43) Pub. Date: May 29, 2014

(54) DIGITIZER PEN, INPUT DEVICE, AND OPERATING METHOD THEREOF

(71) Applicant: SAMSUNG ELECTRO-MECHANICS CO., LTD., Suwon (KR)

(72) Inventors: Jae Hyuk JANG, Suwon (KR); Kyoung Soo Chae, Suwon (KR); Dong Sik Yoo, Suwon (KR); Chang Ryul Jung, Suwon (KR); Hee Bum Lee, Suwon (KR)

(73) Assignee: SAMSUNG ELECTRO-MECHANICS CO., LTD., Suwon (KR)

(21) Appl. No.: 13/835,392

(22) Filed: Mar. 15, 2013

(30) Foreign Application Priority Data
Nov. 23, 2012 (KR) 10-2012-0133701

(51) Int. Cl. G06F 3/0354; G06F 3/046

(52) U.S. Cl. CPC G06F 3/03545; G06F 3/046
USPC 345/174; 345/179

(57) ABSTRACT

There are provided a digitizer pen, an input device, and an operating method thereof. The digitizer pen includes a body unit; and a pair of pen coil units provided in the body unit and disposed adjacently to both ends of the body unit in a length direction thereof, respectively, wherein at least one pen coil unit of the pair of pen coil units is operated by being electromagnetically coupled to a sensor coil close thereto.

### CROSS-REFERENCE TO RELATED APPLICATIONS

This application claims the priority of Korean Patent Application No. 10-2012-0133701 filed on Nov. 23, 2012 in the Korean Intellectual Property Office, the disclosure of which is incorporated herein by reference.

### BACKGROUND OF THE INVENTION

1. Field of the Invention

The present invention relates to a digitizer pen and an input device capable of maximizing user convenience and providing a variety of data input methods by selectively or simultaneously recognizing a plurality of pen coil units in a digitizer module, as necessary, and an operating method thereof.

2. Description of the Related Art

As portable electronic devices such as smartphones, tablet PCs, and the like, become more widespread, research into technology for implementing a variety of functions in a single small, light device has been actively conducted. In particular, electronic devices such as smartphones, tablet PCs, and the like may include an input device capable of being manufactured to be markedly slim, such as in the case of a touchscreen, a touch pad, and the like, so as to provide a variety of data input methods without degrading portability while being carried around by a user, and able to be manufactured integrally with other electronic equipment modules (for example, display modules).

Typically, a touchscreen applied to a portable electronic device may be a capacitance type touchscreen or a resistance film type touchscreen, and in recent years, the capacitance type touchscreen having a superior detection resolution of a touch input and capable of being made thinner has been increasingly applied to the portable electronic device. The capacitance type touchscreen has many advantages compared to the resistance film type touchscreen, but a pen-based data input method available in the resistance film type touchscreen is difficult to be applied to the capacitance type touchscreen.

In particular, as smartphone screens become larger and a wider variety of smartphone applications are developed, a user wishes to perform more diverse and detailed data inputs on the screen of a smartphone or a tablet PC using a pen have increased. When a digitizer module is additionally provided to a lower portion of a display device to overcome disadvantages of capacitance type touchscreens, a variety of data input methods using a separately provided digitizer pen may be provided to a user. However, currently provided digitizer modules and digitizer pens are operated by only a method of recognizing inputs based on signals emitted from one end of the digitizer pen, and therefore it is difficult to provide a variety of data input methods.

In Patent Document 1, a digitizer pen including a single pen coil unit is disclosed. More specifically, in Patent Document 1, an operation of deleting an object displayed on a screen depending on switching a button provided on a body of the digitizer pen on or off is implemented. In addition, in Patent Document 2, a technique for implementing an operation of deleting an object displayed on a screen using a single pen coil unit and a variable capacitor is disclosed. In Patent Document 1 and Patent Document 2, a variety of data input methods such as selection or deletion of an object included in a large area of a screen are not provided.

### RELATED ART DOCUMENTS

(Patent Document 1) Korean Patent Laid-Open Publication No. 10-2006-0119725
(Patent Document 2) Korean Patent Laid-Open Publication No. 10-2012-0031902

### SUMMARY OF THE INVENTION

An aspect of the present invention provides a digitizer pen including a plurality of pen coil units such that the plurality of pen coil units electromagnetically coupled to a digitizer module may be detected in different frequency bands. Accordingly, a variety of data input methods may be provided to users, based on the number of pen coil units and the movement of the pen coil unit detected in the digitizer module, among the plurality of pen coil units.

According to an aspect of the present invention, there is provided a digitizer pen including: a body unit; and a pair of pen coil units provided in the body unit and disposed adjacently to both ends of the body unit in a length direction thereof, respectively, wherein at least one pen coil unit of the pair of pen coil units is operated by being electromagnetically coupled to a sensor coil close thereto.

When any one of the pair of pen coil units is electromagnetically coupled to the sensor coil close thereto, at least one of input, deletion, and selection functions may be provided.

When the pair of pen coil units are electromagnetically coupled to the sensor coil close thereto, at least one of deletion and selection functions with respect to an object included in an area corresponding to the length direction of the body unit may be provided.

In addition, the pair of pen coil units may be electromagnetically coupled to the sensor coil close thereto in different frequency bands, respectively.

According to another aspect of the present invention, there is provided an input device including: a digitizer pen including a plurality of pen coil units; and a panel unit electromagnetically coupled to at least one pen coil unit of the plurality of pen coil units to thereby detect an input by a user, wherein, when being electromagnetically coupled to at least two pen coil units of the plurality of pen coil units, the panel unit detects an input with respect to an object included in an area between the at least two pen coil units.

The digitizer pen may include a body unit and the plurality of pen coil units provided on both ends of the body unit in a length direction thereof.

The plurality of pen coil units may be electromagnetically coupled to the panel unit in different frequency bands.

When being electromagnetically coupled to the at least two pen coil units of the plurality of pen coil units, the panel unit may delete or select the object included in the area between the at least two pen coil units in accordance with movement of the digitizer pen.

The panel unit may include a sensor coil unit electromagnetically coupled to at least one pen coil unit of the plurality of pen coil units, and a control unit calculating the number and coordinates of pen coil units electromagnetically coupled to the sensor coil unit to thereby detect an input.

According to another aspect of the present invention, there is provided an operating method of an input device, including: detecting a pen coil unit close to the input device through a sensor coil unit; and processing an input operation in accordance with movement of the pen coil unit close to the input device, wherein, when the pen coil unit close to the input device is determined as a plurality of pen coil units, an input operation with respect to an object included between coordinates of the plurality of pen coil units close to the input device is processed.

The detecting of the pen coil unit may include detecting the plurality of pen coil units close to the input device in different frequency bands.

When the pen coil unit close to the input device is determined as the plurality of pen coil units, the processing of the input operation may include processing a selection operation or a deletion operation with respect to the object included between the coordinates of the plurality of pen coil units close to the input device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the appearance of an electronic apparatus capable of including an input device according to an embodiment of the present invention;

FIG. 2 is a perspective view illustrating the appearance of a digitizer pen according to an embodiment of the present invention;

FIGS. 3 and 4 are views illustrating an operating method of an input device according to an embodiment of the present invention; and

FIG. 5 is a flowchart illustrating an operating method of an input device according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

Hereinafter, embodiments of the present invention will be described in detail with reference to the accompanying drawings so that those skilled in the art may easily practice the present invention.

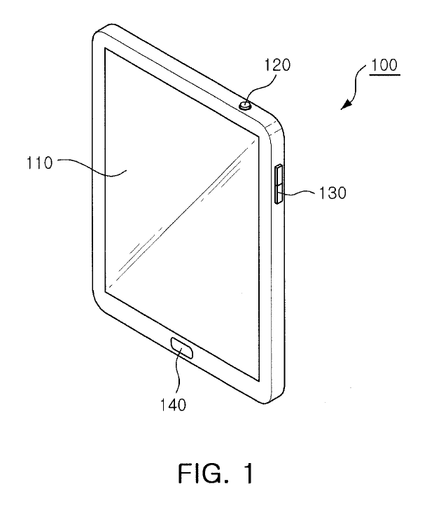

FIG. 1 is a perspective view illustrating the appearance of an electronic apparatus 100 capable of including an input device according to an embodiment of the present invention.

Referring to FIG. 1, the electronic apparatus 100 according to an embodiment of the present invention includes a display device 110, and input units 120, 130, and 140, and a touchscreen device may be integrally formed with the display device 110.

In addition, the electronic apparatus 100 may include an input device using a digitizer pen according to an embodiment of the present invention, and a digitizer module for detecting an input by the digitizer pen may also be integrally formed with the display device 110.

The touchscreen device provided integrally with the display device 110 may be generally provided on a front surface of the display device 110. Accordingly, the touchscreen device should have a degree of light transmittivity sufficient to allow an image output by the display device 110 to be transmitted therethrough. For this, the touchscreen device may be implemented in such a manner that a sensing electrode made of an electrical conductive material such as indium-tin oxide (ITO), indium-zinc oxide (IZO), zinc oxide (ZnO), carbon nano tube (CNT), conductive polymer, or graphene is formed on a base substrate made of a transparent film material such as polyethylene terephthalate (PET), polycarbonate (PC), polyethersulfone (PES), polyimide (PI), or the like.

According to the embodiment of the present invention, the digitizer module for detecting the input by the digitizer pen may be disposed on a rear surface of the display device 110. The display device 110 provided in the electronic apparatus 100 may be typically a flat panel display (FPD) device, for example, a liquid crystal display (LCD) device, an organic light-emitting display device (OLED), or the like. In a case in which the display device 110 is a liquid crystal display (LCD) device, the digitizer module may be disposed on a rear surface of a backlight unit (BLU) of the liquid crystal display (LCD) device, and this is because a sensor coil pattern included in the digitizer module may be made of an opaque material.

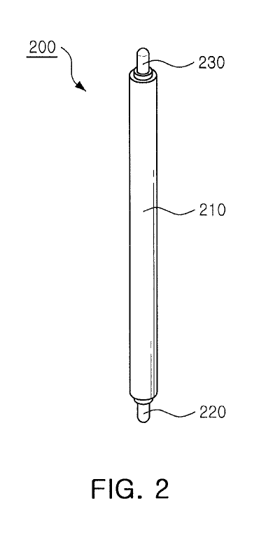

FIG. 2 is a perspective view showing the appearance of a digitizer pen 200 according to an embodiment of the present invention.

Referring to FIG. 2, the digitizer pen 200 according to an embodiment of the present invention includes a body unit 210 and a plurality of pen coil units 220 and 230 provided adjacently to both ends of the body unit 210. In FIG. 2, the digitizer pen 200 in which the pen coil units 220 and 230 are respectively provided on both ends of the body unit 210 in a length direction is illustrated, but the present invention is not limited thereto. In addition, for convenience of description, it is assumed that the digitizer pen 200 according to the embodiment of the present invention is operated in an electromagnetic resonance (EMR) scheme.

In order to detect position information of the digitizer pen 200 by the digitizer module operated in the EMR scheme, a predetermined resonant circuit is provided inside the digitizer pen 200. The resonant circuit may include a capacitor and an inductor, and detect signals generated in the resonant circuit inside the digitizer pen 200 through a plurality of loop coils included in the digitizer module.

Here, frequency characteristics of signals transmitted from the digitizer pen 200 to the digitizer module may be determined by values of the capacitor and the inductor that are included in the resonant circuit inside the digitizer pen 200. According to the present embodiment, when the plurality of pen coil units 220 and 230 are provided in a single digitizer pen 200, the digitizer pen 200 may be designed so that signals having different frequency characteristics are output from the respective pen coil units 220 and 230. That is, the digitizer pen 200 may be designed to include a plurality of resonant circuits, or the digitizer pen 200 may be set to allow the signals having different frequency characteristics to be output using a variable capacitor. The signals having different frequency characteristics are output from the respective pen coil units 220 and 230, and therefore the digitizer module may distinguish the pen coil units 220 and 230 which are currently used for the input operation by a user, and provide different input interfaces based on corresponding information.

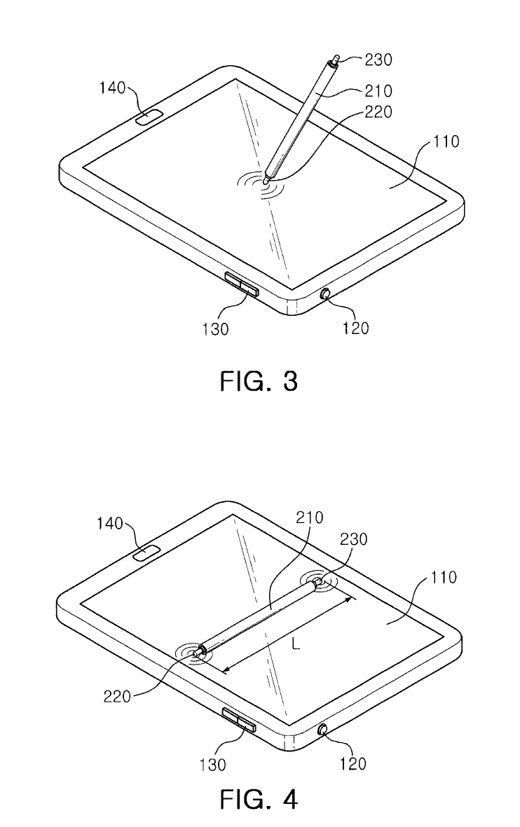

FIGS. 3 and 4 are views illustrating an operating method of an input device according to an embodiment of the present invention.

FIG. 3 shows a method of transmitting a desired input to the display device 110 of the electronic apparatus by a user using the digitizer pen in a general method. Referring to FIG. 3, a first pen coil unit 220 among the plurality of pen coil units 220 and 230 provided in the digitizer pen is close to the display device 110, whereas a second pen coil unit 230 is spaced far away from the display device 110. Accordingly, the digitizer module provided in the electronic apparatus may only detect signals generated in the first pen coil unit 220 close to the sensor coil, and in this case, a user's input may be processed by the same operation as that of a general digitizer pen including a single pen coil unit.

Meanwhile, even in the case that only a single pen coil unit is detected, inputs may be processed differently depending on whether the detected pen coil unit is the first pen coil unit 220 or the second pen coil unit 230. For example, when a user wishes to input characters or draw a picture through an image displayed on the display device 110, a case in which signals output through the first pen coil unit 220 are detected and a case in which signals output through the second pen coil unit 230 are detected may be distinguished from one another, thereby controlling characters to be input with different fonts, sizes, and languages.

When an application for drawing a picture is operated, the first pen coil unit 220 and the second pen coil unit 230 are distinguished from one another to allow lines to be expressed with different colors or different thicknesses or to allow surfaces to be expressed with different textures. Through the above-described method, an input mode may be switched by a desired method by simply changing an orientation of the digitizer pen without being necessary for a user to select desired data input methods from the electronic apparatus.

FIG. 4 is a view illustrating a data input method using all the plurality of pen coil units 220 and 230 provided in the digitizer pen. Referring to FIG. 4, a user makes a digitizer pen close to the display device 110 in a state of laying the digitizer pen down. Accordingly, both the first pen coil unit 220 and the second pen coil unit 230 are made close to the sensor coil of the digitizer module, and therefore the digitizer module may detect all signals output from the first pen coil unit 220 and the second pen coil unit 230.

As described above, the first pen coil unit 220 and the second pen coil unit 230 may be designed to output signals having different frequency characteristics. Accordingly, the digitizer module may detect and distinguish signals output from the first pen coil unit 220 and the second pen coil unit 230, and determine whether two different signals are all detected to thereby implement a variety of operations.

As an example, as shown in FIG. 4, when a user makes the digitizer pen close to the display device 110 and manipulates the digitizer pen in a state of laying the digitizer pen down, the signals output from the first and second pen coil units 220 and 230 are all detected by the digitizer module. The digitizer module may provide, to a main controller chip of the electronic apparatus, information about an area between the first and second pen coil units 220 and 230, that is, an area included in a length direction L of the digitizer pen as shown in FIG. 4. The main controller chip may perform an operation of selecting or simultaneously deleting all of objects (icons, characters, pictures, and the like) included in the corresponding area based on the information received from the digitizer module.

As smartphone screens become larger, and tablet PCs having 7 inch and 10 inch screens become more widespread, and accordingly batch deletion or selection functions with respect to objects included in a large area may maximize user convenience. Meanwhile, the case in which the pen coil units 220 and 230 are provided on both ends of the body unit 210 of the digitizer pen has been assumed in the present embodiment; however, an area desired by a user may be more readily selected or deleted by additionally providing the pen coil units in a center portion of the body unit 210 or adjusting a length of the body unit 210.

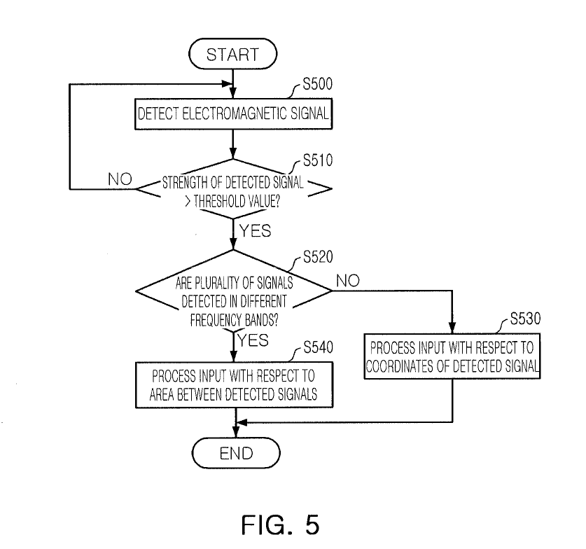

FIG. 5 is a flowchart illustrating an operating method of an input device according to an embodiment of the present invention.

Referring to FIG. 5, in the operating method of the input device according to the present embodiment, the digitizer module detects electromagnetic signals in operation S500. The digitizer pen 200 includes the body unit 210 and the plurality of pen coil units 220 and 230, and the plurality of pen coil units 220 and 230 may output signals having different frequency characteristics, respectively. The digitizer pen 200 may include at least one resonant circuit for outputting radio signals.

In operation S510, the input device determines whether the strength of the detected electromagnetic signal is larger than a predetermined threshold value. When the strength of the electromagnetic signal detected in operation S500 is smaller than the predetermined threshold value, the signal may be generated by electrical noise, rather than by the digitizer pen 200, and therefore, signals generated by a user's intended input and generated by noise may be primarily distinguished from one another in operation S510.

In operation S520, when it is determined that the strength of the detected electromagnetic signal is larger than the threshold value, the input device may determine whether a plurality of signals are detected in different frequency bands. As shown in FIG. 3, when the digitizer pen is used in a state in which only a single pen coil unit 220 is close to the electronic apparatus, signals are only detected in a single frequency band. On the other hand, as shown in FIG. 4, in a state in which the plurality of pen coil units 220 and 230 are simultaneously close to the electronic apparatus, signals are detected in a plurality of frequency bands. Accordingly, based on the determination result in operation S520, the input device may determine a data input method currently intended by a user.

In operation S530, when the signal is only detected in a single frequency band based on the determination result of operation S520, the input device calculates coordinates of the detected signal to process an input. The coordinates determined by the input device are coordinates where the pen coil unit 220 of the digitizer pen is positioned, and the electronic apparatus may perform a specific operation based on the application currently being executed and coordinate information transmitted from the input device.

Meanwhile, in operation S540, when the signals are detected in the plurality of frequency bands based on the determination result of operation S520, the input device calculates coordinates with respect to each of the detected signals, and processes an input with respect to an area between the calculated coordinates. The electronic apparatus may process a plurality of coordinates and a distance between the coordinates as input information, and perform different operations depending on an application currently being executed and a user operation.

For example, when there is no movement until a predetermined threshold time has elapsed in the state in which the digitizer pen is made close to the display device 110 so that the signals are detected in the plurality of frequency bands, the electronic apparatus may be operated to select all objects included in an area between the plurality of detected coordinates. Meanwhile, when the digitizer pen is moved in a specific direction in a state in which the digitizer pen is made close to the display device 110 so that the signals are detected in the plurality of frequency bands, objects displayed on the screen may be batch-deleted along the movement direction.

As set forth above, according to embodiments of the present invention, a digitizer pen may include a plurality of pen coil units, and the plurality of pen coil units may be distinguished using different signal characteristics exhibited in the plurality of pen coil units. Accordingly, a variety of data input methods may be provided to users depending on the number of pen coil units detected by the digitizer module, a distance or a movement between the detected pen coil units, and the like. In particular, by implementing a function of batch-delete or batch-select a plurality of objects included in an area between the detected pen coil units, user convenience may be maximized.

While the present invention has been shown and described in connection with the embodiments, it will be apparent to those skilled in the art that modifications and variations can be made without departing from the spirit and scope of the invention as defined by the appended claims.

What is claimed is:

1. A digitizer pen comprising:
a body unit; and
a pair of pen coil units provided in the body unit and disposed adjacently to both ends of the body unit in a length direction thereof, respectively,
wherein at least one pen coil unit of the pair of pen coil units is operated by being electromagnetically coupled to a sensor coil close thereto.

2. The digitizer pen of claim 1, wherein, when any one of the pair of pen coil units is electromagnetically coupled to the sensor coil close thereto, at least one of input, deletion, and selection functions is provided.

3. The digitizer pen of claim 1, wherein, when the pair of pen coil units are electromagnetically coupled to the sensor coil close thereto, at least one of deletion and selection functions with respect to an object included in an area corresponding to the length direction of the body unit is provided.

4. The digitizer pen of claim 1, wherein the pair of pen coil units are electromagnetically coupled to the sensor coil close thereto in different frequency bands, respectively.

5. An input device comprising:
a digitizer pen including a plurality of pen coil units; and
a panel unit electromagnetically coupled to at least one pen coil unit of the plurality of pen coil units to thereby detect an input by a user,
wherein, when being electromagnetically coupled to at least two pen coil units of the plurality of pen coil units, the panel unit detects an input with respect to an object included in an area between the at least two pen coil units.

6. The input device of claim 5, wherein the digitizer pen includes a body unit and the plurality of pen coil units provided on both ends of the body unit in a length direction thereof.

7. The input device of claim 5, wherein the plurality of pen coil units are electromagnetically coupled to the panel unit in different frequency bands.

8. The input device of claim 5, wherein, when being electromagnetically coupled to the at least two pen coil units of the plurality of pen coil units, the panel unit deletes or selects the object included in the area between the at least two pen coil units in accordance with movement of the digitizer pen.

9. The input device of claim 5, wherein the panel unit includes:
a sensor coil unit electromagnetically coupled to at least one pen coil unit of the plurality of pen coil units; and
a control unit calculating the number and coordinates of pen coil units electromagnetically coupled to the sensor coil unit to thereby detect an input.

10. An operating method of an input device, comprising:
detecting a pen coil unit close to the input device through a sensor coil unit; and
processing an input operation in accordance with movement of the pen coil unit close to the input device,
wherein, when the pen coil unit close to the input device is determined as a plurality of pen coil units, an input operation with respect to an object included between coordinates of the plurality of pen coil units close to the input device is processed.

11. The operating method of claim 10, wherein the detecting of the pen coil unit includes detecting the plurality of pen coil units close to the input device in different frequency bands.

12. The operating method of claim 10, wherein, when the pen coil unit close to the input device is determined as the plurality of pen coil units, the processing of the input operation includes processing a selection operation or a deletion operation with respect to the object included between the coordinates of the plurality of pen coil units close to the input device.
